(19) United States
(12) Patent Application Publication
(10) Pub. No.: US 2014/0186656 A1
(43) Pub. Date: Jul. 3, 2014

(54) Spallation-Resistant Thermal Barrier Coating

(71) Applicant: UNITED TECHNOLOGIES CORPORATION, Hartford, CT (US)

(72) Inventors: Brian S. Tryon, Glastonbury, CT (US); Mario P. Bochiechio, Vernon, CT (US); Russell A. Beers, Manchester, CT (US)

(73) Assignee: UNITED TECHNOLOGIES CORPORATION, Hartford, CT (US)

(21) Appl. No.: 13/731,806

(22) Filed: Dec. 31, 2012

(51) Int. Cl. F02C 7/00

(52) U.S. Cl. CPC F02C 7/00
USPC 428/666; 427/404; 427/580; 427/405

(57) ABSTRACT

A coated article has: a metallic substrate; a bondcoat; and a thermal barrier coating (TBC). The bondcoat has an MCrAlY first layer and an MCrAlY second layer, the second layer having a lower Cr content than the first layer.

### BACKGROUND

The disclosure relates gas turbine engines. More particularly, the disclosure relates to thermal barrier coatings for gas turbine engines.

Gas turbine engine gaspath components are exposed to extreme heat and thermal gradients during various phases of engine operation. Thermal-mechanical stresses and resulting fatigue contribute to component failure. Significant efforts are made to cool such components and provide thermal barrier coatings to improve durability.

Exemplary thermal barrier coating systems include two-layer thermal barrier coating systems. An exemplary system includes NiCoCrAlY bondcoat (e.g., low pressure plasma sprayed (LPPS)) and yttria-stabilized zirconia (YSZ) (or gadolinia-stabilized zirconia (GSZ)) thermal barrier coating (TBC) (e.g., air plasma sprayed (APS) or electron beam physical vapor deposited (EBPVD)). Prior to and while the barrier coat layer is being deposited, a thermally grown oxide (TGO) layer (e.g., alumina) forms atop the bondcoat layer. As time-at-temperature and the number of cycles increase, this TGO interface layer grows in thickness. An exemplary YSZ is 7 weight percent yttria-stabilized zirconia (7YSZ).

Exemplary TBCs are applied to thicknesses of 1-40 mils (0.025-1.0 mm) and can contribute to a temperature reduction of up to 300° F. at the base metal. This temperature reduction translates into improved part durability, higher turbine operating temperatures, and improved turbine efficiency.

Many variations have been proposed. The roles of aluminum, chromium, and noble metals in bondcoats have been explored, for example in U.S. Pat. Nos. 6,270,318, 6,435,826, 6,435,830, 6,435,835, and 7,157,151 and United Kingdom Published Applications 2322382 and 2322383. In the TBC, use of rare earth oxides is discussed in CARLOS G. LEVI, “Emerging materials and processes for thermal barrier systems”, Current Opinion in Solid State & Materials Science, 2004, pp. 77-91, vol. 8, Elsevier Ltd.

### SUMMARY

One aspect of the disclosure involves a coated article having: a metallic substrate; a bondcoat; and a thermal barrier coating (TBC). The bondcoat has an MCrAlY first layer and an MCrAlY second layer, the second layer having a lower Cr content than the first layer.

In additional or alternative embodiments of any of the foregoing embodiments, the TBC comprises: a first layer; and a second layer, the TBC second layer having a higher concentration of a rare earth oxide zirconate than the TBC first layer.

In additional or alternative embodiments of any of the foregoing embodiments: the TBC first layer comprises material selected from the group consisting of yttria-stabilized zirconia or gadolinia-stabilized zirconia or combinations thereof; and the TBC second layer comprises yttria-stabilized zirconia or gadolinia-stabilized zirconia.

In additional or alternative embodiments of any of the foregoing embodiments, the article consisting essentially of the substrate, the bondcoat first layer, the bondcoat second layer, and the TBC first layer, and the TBC second layer.

In additional or alternative embodiments of any of the foregoing embodiments, the rare earth is selected from the group consisting of: Nd, Sm, Eu, Gd, Dy, Er and combinations thereof.

In additional or alternative embodiments of any of the foregoing embodiments, by weight percent: the bondcoat first layer comprises 20-40 Cr, up to 30 Co, 6.5-13 Al, up to 2 Y, and up to 2 Hf; and the bondcoat second layer comprises 1-18 Cr, 1-30 Co, 1-15 W, 1-12 Ta, 6.5-15 Al, up to 2 Y, up to 2 Hf up to 2 Si, and up to 2 Zr.

In additional or alternative embodiments of any of the foregoing embodiments: the boncoat first layer has a chromium content at least 10 weight percent higher than a chromium content of the bondcoat second layer; and the bondcoat second layer has an aluminum content at least 5 weight percent higher than an aluminum content of the bondcoat first layer.

In additional or alternative embodiments of any of the foregoing embodiments, the substrate comprises a nickel based superalloy.

In additional or alternative embodiments of any of the foregoing embodiments, the nickel based superalloy comprises, in weight %, 5.5-19 Cr, 1.5-13 Co, up to 6 Mo, up to 7.5 Mo, up to 8 Ti, up to 15 Ta, up to 9 Al, and up to 0.05 B.

In additional or alternative embodiments of any of the foregoing embodiments, the article consists essentially of the substrate, the bondcoat first layer, the bondcoat second layer, and the TBC.

In additional or alternative embodiments of any of the foregoing embodiments, a method for manufacturing the article comprises: applying the bondcoat first layer having an as-applied weight % composition comprising 20-40 Cr, up to 30 Co, 6.5-15 Al, up to 2 Y, and up to 2 Hf; and applying the bondcoat second layer atop the bondcoat first layer and having an as-applied weight % composition comprising 1-18 Cr, 1-30 Co, 1-15 W, 1-12 Ta, 6.5-15 Al, up to 2 Y, up to 2 Hf up to 2 Si, up to 2 Zr.

In additional or alternative embodiments of any of the foregoing embodiments, the applying of the bondcoat first layer and of the bondcoat second layer are applied by cathodic arc deposition.

In additional or alternative embodiments of any of the foregoing embodiments: the bondcoat second layer is applied directly atop the bondcoat first layer; and the TBC is applied directly atop the bondcoat second layer.

In additional or alternative embodiments of any of the foregoing embodiments: the TBC comprises a first layer and a second layer atop the first layer; and the TBC second layer has a higher rare earth oxide zirconate content than the TBC first layer.

In additional or alternative embodiments of any of the foregoing embodiments: a characteristic thickness of the bondcoat first layer is 0.02 mm to 0.1 mm; and a characteristic thickness of the bondcoat second layer is 0.02 mm to 0.1 mm.

In additional or alternative embodiments of any of the foregoing embodiments: a characteristic thickness of the TBC first layer is 0.025 mm to 0.25 mm; and a characteristic thickness of the TBC second layer is 0.25 mm to 1.0 mm.

In additional or alternative embodiments of any of the foregoing embodiments, the TBC first layer and TBC second layer comprise yttria-stabilized zirconia or gadolinia-stabilized zirconia.

In additional or alternative embodiments of any of the foregoing embodiments, the substrate comprises a nickel-based superalloy.

Another aspect of the disclosure involves a method for forming a coated article. The method comprises: applying an MCrAlY first bondcoat layer a to a metallic substrate; applying an MCrAlY second bondcoat layer atop the first bondcoat layer, the second bondcoat layer having a lower Cr content than the first bondcoat layer; and applying a thermal barrier coating (TBC) atop the second bondcoat layer.

In additional or alternative embodiments of any of the foregoing embodiments, the first bondcoat layer may be applied directly atop the substrate; and the second bondcoat layer may be applied directly atop the first bondcoat layer.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a partially schematic sectional view of substrate having a thermal barrier coating (TBC).

FIG. 2 is a partially schematic sectional view of substrate having a second thermal barrier coating (TBC).

FIG. 3 is a partially schematic view of a vane bearing the TBC.

FIG. 4 is a partially schematic view of a blade bearing the TBC.

FIG. 5 is a flowchart of a process for coating the substrate of FIG. 1.

FIG. 6 is a table of alloy compositions.

FIG. 7 is a table of advanced bondcoat compositions.

FIG. 8 is a table of high-Cr bondcoat compositions.

Like reference numbers and designations in the various drawings indicate like elements.

### DETAILED DESCRIPTION

FIG. 1 shows a thermal barrier coating system 20 atop a metallic substrate 22. In an exemplary embodiment, the substrate is a nickel-based superalloy or a cobalt-based superalloy such as a cast component (e.g., a single crystal casting) of a gas turbine engine. Exemplary components are hot section components such as combustor panels, turbine blades, turbine vanes, and air seals.

Numerous high-chromium alloy systems have been developed to counteract the corrosive nature of the combustion gasses that flow past the turbine components. These alloys have been designed for all three subsets of the investment casting process: equiaxed; directionally solidified—columnar; and directionally solidified—single crystal (SX). As the design of the turbine engine has been modified to meet performance demands, the alloys have been tailored to meet the desired properties specified by the design and application. Furthermore the alloys have been further tailored to accommodate the casting process.

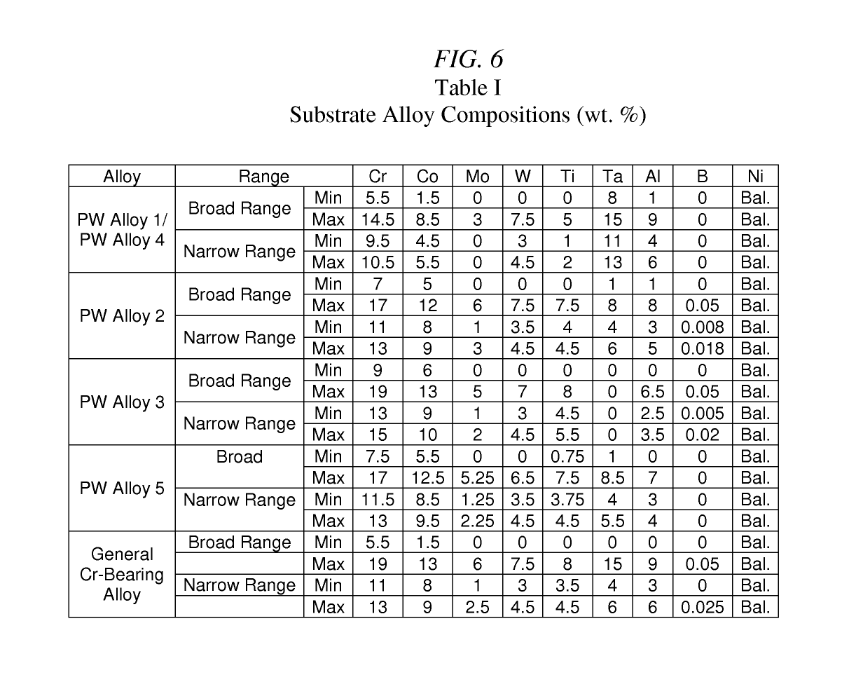

Examples of corrosion-resistant alloys for the directional solidification processes are: PW Alloy 1, PW Alloy 2, PW Alloy 3, PW Alloy 4, and PW Alloy 5. These alloys are further classified by the end use of the alloy. PW Alloy 1 and PW Alloy 4 are used in aero engines were corrosion resistance and thermal fatigue resistance are key performance attributes. PW Alloy 2, PW Alloy 3, and PW Alloy 5 are targeted toward industrial gas turbine (IGT) applications. IGT engines have a mode of operation where they are run at constant speeds for long periods of time to meet the needs of power generation. These engines are typically run at lower temperatures than aero engines. Thus IGT creep and thermal fatigue requirements are different than aero engines' allowing for chemistry differences to optimize performance in the different operating regime. While these alloys and their coatings have been chosen/tailored for aero or IGT end use, they are not limited to aero or IGT use or even turbine engine use, generally. Exemplary compositional ranges are shown in Table I of FIG. 6. In some embodiments of the materials in Table I (and Tables II and III below), the materials may consist essentially of the listed elements (e.g., with at most trace amounts of other elements). In some embodiments, other elements may be present in individual quantities less than 2.0 weight percent and/or aggregate quantities less than 5.0 weight percent, more narrowly 1.0 weight percent individually and 2.0 weight percent aggregate.

The coating system 20 may include a bondcoat 30 atop a surface 26 of the substrate 22 and a thermal barrier coating (TBC) system 28 atop the bondcoat. A thermally grown oxide (TGO) layer 24 may form at the interface of the bondcoat to the TBC. The bondcoat is a multi-layer bondcoat with at least two layers. A first layer 32 is a lower layer. A second layer 34 is over the first layer. In the exemplary system, the bondcoat consists of or consists essentially of the first and second layers (e.g., subject to relatively small gradation/transition with each other and with the TBC as noted above).

The TBC is a multi-layer TBC with at least two layers. A first layer 40 is a lower layer. A second layer 42 is over the first layer. In the exemplary system, the TBC consists of or consists essentially of the first and second layers (e.g., subject to relatively small gradation/transition with each other and with the bondcoat as noted above).

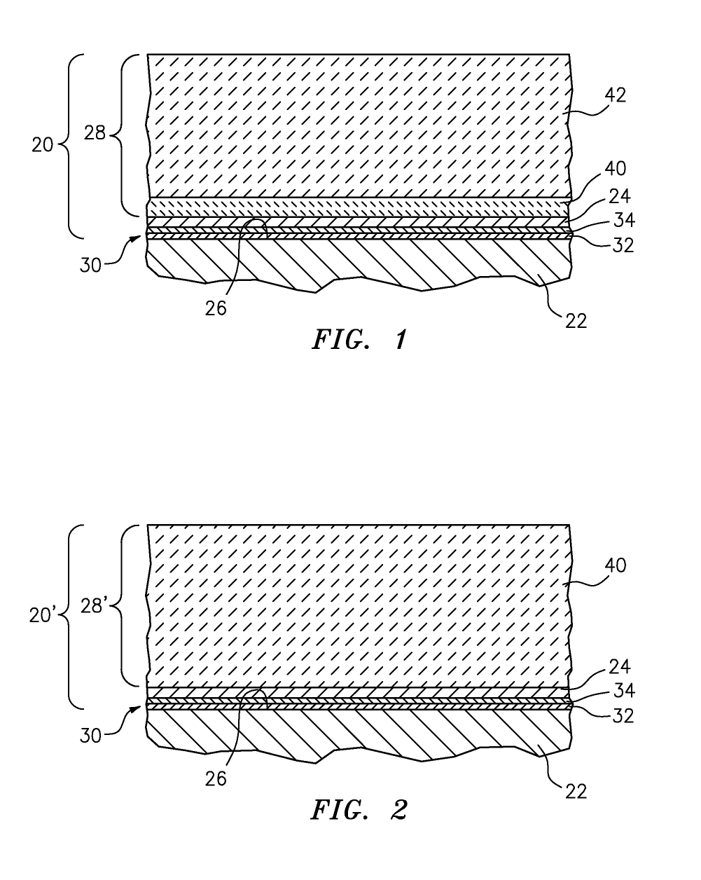

FIG. 2 shows a vane 50 comprising the cast metallic substrate 22. The vane includes an airfoil 52 having a surface comprising a leading edge 54, a trailing edge 56, a pressure side 58, and a suction side 60. The airfoil extends from an inboard end at a platform or band segment 62 to an outboard end and an outboard shroud or band segment 64. The segments 62 and 64 have respective gaspath surfaces 66 and 68. These are essentially normal to the airfoil surfaces. The TBC system extends at least along the surface of the airfoil and the surfaces 66 and 68.

The exemplary bondcoat 30 is a metallic bondcoat such as an MCrAlY overlay bondcoat. For each of the layers 32 and 34 of the bondcoat 30, an exemplary MCrAlY overlay bondcoat is a NiCoCrAlY, more particularly a NiCoCrAlYHfSi.

Exemplary bondcoat thicknesses are 2-500 micrometers, more narrowly, 12-250 micrometers or 25-150 micrometers on average.

The layers 32 and 34 may differ in composition from each other and from more typical bondcoats in several manners. Exemplary layer 32 is a high chrome NiCoCrAlYHfSi, referred to as HiCrBC. This has a high Cr content (e.g., ≧20 wt %, more particularly, ≧25 wt %, or 20-40 wt % or 25-40 wt % or 25-35 wt % as applied). This bondcoat material provides excellent corrosion resistance at temperature below 1800° F. It was not developed for use as a traditional bondcoat. Its current application is targeted areas that show a corrosion issues. HiCrBC has been tested at elevated temperatures and shows a debit in life versus a typical NiCoCrAlY due to the lower aluminum content. When used alone at higher temperatures this material will rumple and cause premature spallation of the ceramic top coat(s).

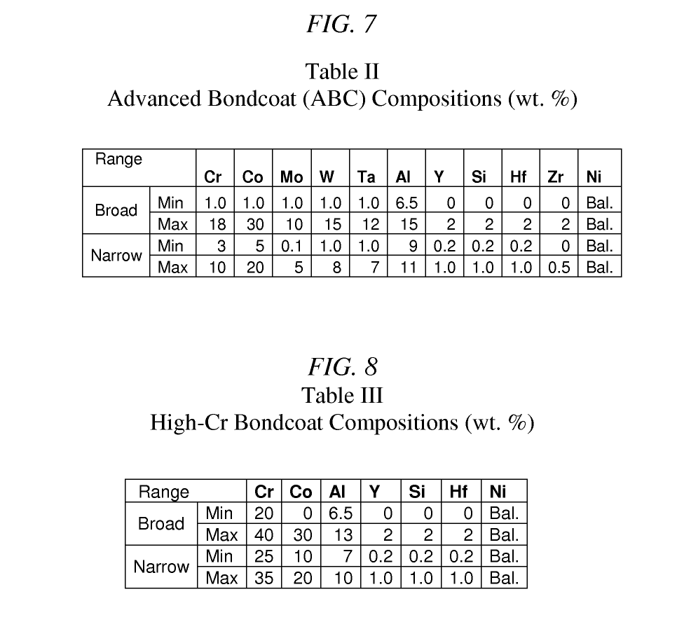

Exemplary layer 34 is an advanced bondcoat (ABC) having composition chosen to complement layer 32. For example, the ABC 34 may ensure oxidation and spallation lives of the ceramic top coat. This is enabled through the formation of an alumina (Al₂O₃) based thermally grown oxide (TGO) 24. To achieve this, the ABC 34 may have a high aluminum content. Exemplary compositional ranges are shown in Table II of FIG. 7.

The presence, in the bondcoat, of active elements such as yttrium, hafnium, silicon, and zirconium further improve the adherence of the thermally grown oxide to the ceramic top coat and bondcoat.

Whereas the HiCrBC composition contains a moderate amount of aluminum, it is lower than in the ABC (e.g., by at least 2 weight percent or by at least 3 weight percent or, more narrowly, by at least 5 weight percent). This limits effectiveness of the HiCrBC used alone in an oxidizing atmosphere.

Additionally the high chromium content in the HiCrBC will favor the formation of chromia (Cr₂O₃) at intermediate temperatures. While effective against corrosion products, chromia is less effective than alumina for top coat adherence. Exemplary as-applied Cr content in the HiCrBC will typically be at least 10 weight percent higher than in the ABC, more narrowly at least 15 weight percent or at least 20 weight percent.

Over time in operation, as the corrosive salts react with the ceramic TBC, the thermal gradient created by the ceramic will be reduced as thermal conductivity of the TBC is increased. This will largely be the result of: (a) a reduction in porosity; and (b) a reduction in thickness of the ceramic due to spallation. As the temperature of the underlying bondcoat and substrate increase, the diffusion rate of chromium from the HiCrBC 32 will increase to adjacent areas that have lower concentrations of chromium. This will smooth a gradient of chromium from the layer 32 into the layer 34 during operation of the engine. The ABC 34 will eventually spall as the chromium present in the advanced bondcoat layer is consumed through reaction with the corrosive salts. This will expose the underlying HiCrBC layer which will continue to provide corrosion resistance during the operation of the engine. When in the presence of corrosive material (e.g., corrosive salts such as Na₂SO₄, NaCl, and V₂O₅) deterioration of the bondcoat compositions with lower chromium content will accelerate. The corrosion-resistant coating will provide resistance to the corrosive salts that are ingested from the intake air during the operation of the engine or as contaminants in the fuel. Chromium will react with the molten salts by forming stable compounds such as Na₂Cr0₄. The high chromium content alloy of the layer 32 then serves as a last resort to provide resistance to the salts after all other materials have failed.

This ABC composition (alone) outperforms HiCrBC (alone) in oxidation and TBC spallation life. The ABC bondcoat (alone) layer offers a 10-15% improvement in oxidation live and 5-8× improvement in TBC spallation life vs. a standard MCrAlY such as PWA 286.

Exemplary thicknesses of each of the layers 32 and 34 is broadly 0.02 to 0.20 mm; narrowly 0.02 to 0.1 mm. Deposition techniques include air plasma spray (APS), low pressure plasma spray (LPPS), high velocity oxy fuel (HVOF), sputtering, cathodic arc deposition. Relative thicknesses may be about equal to each other (e.g., with both layers representing about 20-80% total thickness (locally or average), more particularly 40-60%). The relative importance of the respective properties of these two layers in a given application may influence which layer is thicker.

The layers 40 and 42 may differ from each other in that the layer 42 has a greater concentration of a rare earth oxide zirconate (REO-ZrO₂). Exemplary materials for the layers 40 and 42 may be of similar nominal base composition (e.g., 7YSZ, more broadly 6-8 wt % yttria, or other YSZ or GSZ or combination) or may be of differing nominal base compositions. Exemplary REO-ZrO₂ content of the layer 42 is 30-60 wt % with a proportional reduction in the base material (e.g., 7YSZ) content. The layer 40 may have much lower, if any, REO-ZrO₂ (e.g., less than 10 wt % or less than 5 wt %).

Rare earth oxides that are suitable to this use are those contained within the lanthanide series La (Element 57) through Lu (Element 71).

Inclusion of the rare earth oxide zirconate of a stabilized cubic fluorite or cubic pyrochlore type will ensure low thermal conductivity through the ceramic material through phonon scattering and radiation component of thermal conductivity.

Rare earth oxides such as Nd, Sm, Eu, Gd, Dy, and Er are known to form either the fluorite or pyrocholore structures based on the mol percent of oxide that is mixed with zirconia. For example, Nd₂O₃ mixed with ZrO₂ at 20 mol % Nd₂O₃ will display a characteristic fluorite x-ray diffraction pattern. Whereas at 33.3 mol percent Nd₂O₃, forming Nd₂Zr₂O₇, the pyrocholore phase will be observed during x-ray analysis. Given the high energy input that is required to convert the rare earth zirconate to the pyroclore structure, incomplete conversation to this phase has been observed, namely a mixed fluorite-pyroclore phase has been observed in the thermal barrier coating.

Inclusion of the rare earth oxide zirconate of a cubic stabilized fluorite and/or pyrochlore type will ensure low thermal conductivity through the ceramic material through phonon scattering and the radiation component of thermal conductivity.

Additionally, the rare earth oxides will provide resistance to the corrosive salts by forming a reaction product that arrests the infiltration of the salts further into the coating. The rare earth based coatings also display a lower thermal conductivity than 7YSZ. This will result in a larger observed thermal gradient across the thickness of the coating. The reduction in observed thermal conductivity will increase the lives of both the ABC 34 and HiCrBC 32 by reducing the rate of formation of the thermally grown oxide.

Whereas zirconia compounds are oxygen-transparent, the thermally grown oxide, alumina, serves as an oxygen diffusion barrier. Furthermore, lower temperatures will reduce rumpling (creep) of the bondcoat relative to the underlying substrate. The resulting reduction in stress at the bondcoat-TGO interface will improve the adherence of the top coat to the TGO and bondcoat as the system undergoes thermal expansion and contraction as the turbine component is cycled. This improved adherence will result in less delamination of the TGO and ultimately less liberation of the ceramic top coat through the reduction of cyclic stresses.

Relative thicknesses (local or average (e.g., mean, median, or modal)) of the TBC layers may be such that the layer 42 is thicker than the layer 40 (e.g., at least twice as thick, more particularly at least four times, five times, or ten times or an exemplary five-fifty times).

An exemplary combined thickness (local or average) of the two TBC layers is in excess of 0.005 inch (0.13 mm), more particularly at least 0.010 inch (0.25 mm) or an exemplary 0.010 inch to 0.050 inch (0.25 mm to 1.3 mm) or 0.010 inch to 0.020 inch (0.25 mm to 0.5 mm)

An exemplary first layer 40 thickness is at least 0.001 inch (0.025 mm) (more particularly, 0.001-0.01 inch (0.025-0.25 mm). These two layers may be applied by techniques including APS, EB-PVD, SPS, SPPS, and slurry coating.

An exemplary thickness of the second layer 42 is at least 0.010 inch (0.25 mm) with an exemplary range of 0.010-0.040 inch (0.25-1.0 mm). Such exemplary layer thickness may be a local thickness or an average thickness.

An alternative embodiment of FIG. 2 has a coating 20′ with a TBC 28′ having a single layer of the material 40. This will provide limited protection in the presence of corrosive salts. It will have lower life in comparison to rare earth oxide zirconate materials which will form arresting phases in the presence of the corrosive materials.

FIG. 3 shows a blade 100 having an airfoil 102 extending outward from a platform 104. The blade includes an attachment root 106 inboard of the platform. The platform 104 has an outboard gaspath surface 108.

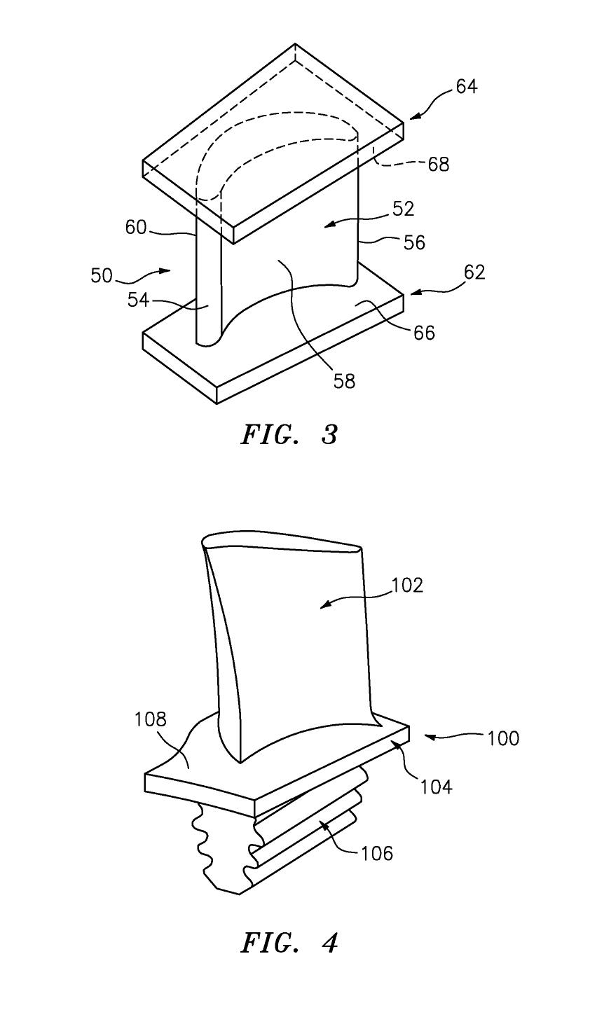

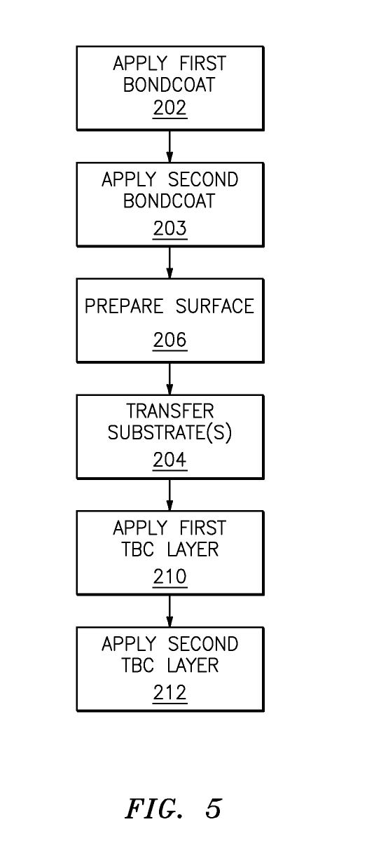

FIG. 4 shows an exemplary process 200 for coating the substrate. After initial substrate manufacture (e.g., casting, finish machining, cleaning, and the like) the bondcoat first layer 32 is applied 202 and the second layer 34 then applied 203. This may be done by cathodic arc deposition (e.g., or other methods as described above). Both stages may be performed in a single chamber (not shown; or in two chambers with transfer in between) whereafter the substrate(s) are transferred 204 to a second chamber (not shown) for TBC deposition.

A surface preparation 206 may comprise further cleaning and/or grit blasting (e.g., in yet other chambers) prior to reaching the second chamber. There may also be thermal conditioning via heater (not shown). The TBC first layer 40 may be applied 210 via EB-PVD in the second chamber. A further surface preparation (not shown) may follow and may require removal from the second chamber.

After application of the first layer, the second layer 42 is then applied 212 (e.g., by the same method in the same chamber but using at least a partially differing source (e.g., adding deposition from an ingot of the rare earth oxide zirconate to deposition from an ingot of the base material (e.g., 7YSZ) or switching form an ingot of the 7YSZ to an ingot of the combined material)).

Additional layers may be deposited (whether in the aforementioned chambers or otherwise). The exemplary embodiment, however, terminates coating after the second layer is applied.

One or more embodiments have been described. Nevertheless, it will be understood that various modifications may be made. For example, implemented in the remanufacture of a given article for the reengineering of the configuration of such article, details of the baseline and its use may influence details of any particular implementation. Accordingly, other embodiments are within the scope of the following claims.

1. A coated article comprising:
a metallic substrate;
a bondcoat comprising:
an MCrAlY first layer; and
an MCrAlY second layer, the second layer having a lower Cr content than the first layer; and
a thermal barrier coating (TBC).

2. The article of claim 1 wherein:
the TBC comprises:
a first layer; and
a second layer, the TBC second layer having a higher concentration of a rare earth oxide zirconate than the TBC first layer.

3. The article of claim 2 wherein:
the TBC first layer comprises material selected from the group consisting of yttria-stabilized zirconia or gadolinia-stabilized zirconia or combinations thereof; and
the TBC second layer comprises yttria-stabilized zirconia or gadolinia-stabilized zirconia.

4. The article of claim 2 consisting essentially of the substrate, the bondcoat first layer, the bondcoat second layer, and the TBC first layer, and the TBC second layer.

5. The article of claim 2 wherein the rare earth is selected from the group consisting of:
Nd, Sm, Eu, Gd, Dy, Er and combinations thereof.

6. The article of claim 1 wherein by weight percent:
the bondcoat first layer comprises 20-40 Cr, up to 30 Co, 6.5-13 Al, up to 2 Y, up to 2 Hf; and
the bondcoat second layer comprises 1-18 Cr, 1-30 Co, 1-15 W, 1-12 Ta, 6.5-15 Al, up to 2 Y, up to 2 Hf, up to 2 Si, up to 2 Zr.

7. The article of claim 6 wherein:
the boncoat first layer has a chromium content at least 10 weight percent higher than a chromium content of the bondcoat second layer; and
the bondcoat second layer has an aluminum content at least 5 weight percent higher than an aluminum content of the bondcoat first layer.

8. The article of claim 1 wherein:
the substrate comprises a nickel-based superalloy.

9. The article of claim 8 wherein:
the nickel-based superalloy comprises in weight % 5.5-19 Cr, 1.5-13 Co, up to 6 Mo, up to 7.5 W, up to 8 Ti, up to 15 Ta, up to 9 Al, up to 0.05 B.

10. The article of claim 1 consisting essentially of the substrate, the bondcoat first layer, the bondcoat second layer, and the TBC.

11. A method for manufacturing the article of claim 1, the method comprising:
applying the bondcoat first layer having an as-applied weight % composition comprising 20-40 Cr, up to 30 Co, 6.5-15 Al, up to 2 Y, up to 2 Hf; and
applying the bondcoat second layer atop the bondcoat first layer and having an as-applied weight % composition comprising 1-18 Cr, 1-30 Co, 1-15 W, 1-12 Ta, 6.5-15 Al, up to 2 Y, up to 2 Hf,. up to 2 Si, up to 2 Zr.

12. The method of claim 11 wherein:
the applying of the bondcoat first layer and of the bondcoat second layer are applied by cathodic arc deposition.

13. The method of claim 11 wherein:
the bondcoat second layer is applied directly atop the bondcoat first layer; and
the TBC is applied directly atop the bondcoat second layer.

14. The method of claim 11 wherein:
the TBC comprises a first layer and a second layer atop the first layer;
the TBC second layer has a higher rare earth oxide zirconate content than the TBC first layer.

15. The method of claim 14 wherein:
a characteristic thickness of the bondcoat first layer is 0.02 mm to 0.1 mm; and
a characteristic thickness of the bondcoat second layer is 0.02 mm to 0.1 mm.

16. The method of claim 14 wherein:
a characteristic thickness of the TBC first layer is 0.025 mm to 0.25 mm; and
a characteristic thickness of the TBC second layer is 0.25 mm to 1.0 mm.

17. The method of claim 11, wherein:
the TBC first layer and TBC second layer comprise yttria-stabilized zirconia or gadolinia-stabilized zirconia.

18. The method of claim 11, wherein:
the substrate comprises a nickel-based superalloy.

19. A method for forming a coated article, the method comprising:
applying an MCrAlY first bondcoat layer a to a metallic substrate;
applying an MCrAlY second bondcoat layer atop the first bondcoat layer, the second bondcoat layer having a lower Cr content than the first bondcoat layer; and
applying a thermal barrier coating (TBC) atop the second bondcoat layer.

20. The method of claim 19 wherein:
the first bondcoat layer is applied directly atop the substrate; and
the second bondcoat layer is applied directly atop the first bondcoat layer.
